(19) United States
(12) Patent Application Publication
(10) Pub. No.: US 2005/0178823 A1
(43) Pub. Date: Aug. 18, 2005

(54) Information displaying system

(75) Inventors: Masaya Kuwahara, Owariasahi (JP); Hiroshi Nishimiya, Owariasahi (JP); Yoshitaka Shibata, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-Omron Terminal Solutions, Corp., Tokyo (JP)

(21) Appl. No.: 11/003,268

(22) Filed: Dec. 2, 2004

(30) Foreign Application Priority Data
Feb. 13, 2004 (JP) 2004-035905

(51) Int. Cl. G06F 17/60

(52) U.S. Cl. 235/379

(57) ABSTRACT

An improvement of a system for providing more effectively product information has been required. The required improvement can be achieved by a technology, for example, that displays information corresponding to a point message displayed on an automated teller machine on a display unit installed in the proximity of the automated teller machine and displays more detailed information to customers who show any interest. The displayed information preferably corresponds to customer information (such as account number) acquired by the automated teller machine. The system further includes a sensor for detecting the approach of the customer to the display unit and switches display of an info-active screen in accordance with the approach or halt of the customer.

### INCORPORATION BY REFERENCE

The present application claims priority from Japanese application JP 2004-035905 filed on Feb. 13, 2004, the content of which is hereby incorporated by reference into this application.

### BACKGROUND OF THE INVENTION

This invention relates to a system that provides such as merchandise information to a customer using an automated teller machine (ATM) in a financial institution, or the like.

JP-A-11-120265 discloses a technology that provides information of financial products (commodity) corresponding to the balance of deposit to customers utilizing an automated teller machine. JP-A-2003-323659 discloses a technology that displays a campaign picture on an automated teller machine.

### SUMMARY OF THE INVENTION

However, the technologies of the patent documents described above involve the problem that an occupying time of the automated teller machine gets elongated because the product information is displayed on the automated teller machine. When the occupying time of the automated teller machine becomes longer, other customers feel annoying, the operation ratio of the automated teller machine drops and the customer now operating the automated teller machine is nervous about other customers waiting behind him and does not sufficiently look the product information. Therefore, an improvement of the system that more effectively provides the product information has been required.

As an improvement, the inventor provides a technology that displays merely a point message at the end of transaction of the automated teller machine to attract the customer's attention and releases at an early stage the occupation of the automated teller machine, for example. The inventor provides also an apparatus/system/method that operates an automated teller machine in the interlocking arrangement with an information display apparatus. In other words, the inventor provides a technology that displays more detailed information for a customer showing an interest by displaying information corresponding to a point message on the automated teller machine on an info-active screen set up in the proximity of the automated teller machine. The information to be displayed is preferably those which correspond to customer information (account number, for example) acquired by the automated teller machine.

A sensor is installed to detect the approach of the customer to the info-active screen and to switch the display on the info-active screen when the customer approaches or comes to a halt. The display content of the info-active screen when the customer approaches or comes to a halt is recorded in a server as the information to which the customer shows its interest.

This invention makes it possible to shorten the occupying time of the automated teller machine and to provide financial product information to customers. The invention actualizes and/or records those information in which the customers seem to be interested.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of a system;

FIG. 2 is a flowchart;

FIG. 3 shows an example of a table of a customer file;

FIG. 4 is a perspective view showing an example of an info-active screen and a proximity sensor;

FIG. 5 shows an example of an info-active screen 1;

FIG. 6 shows an example of an info-active screen 2;

FIG. 7 shows an example of an info-active screen 3; and

FIG. 8 shows an example of an info-active screen 4.

### DESCRIPTION OF THE EMBODIMENT

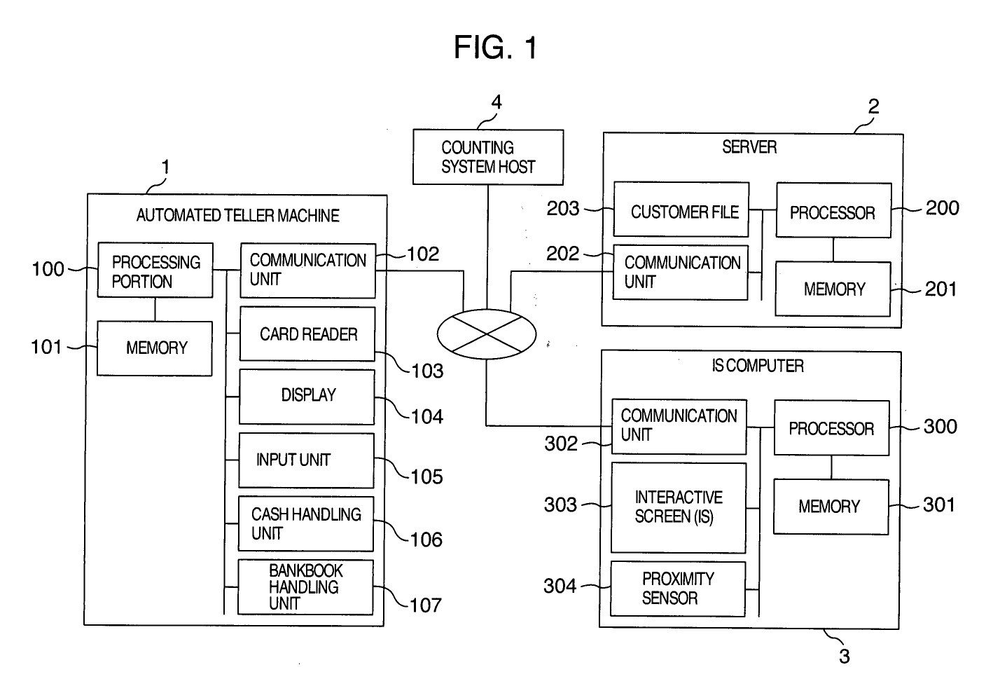

Provision of financial product information to a customer utilizing an automated teller machine (ATM) installed in a financial institution will be explained as a preferred embodiment of the invention with reference to FIGS. 1 to 8. However, the object of the invention is not limited to the financial institution and its construction and processes may be appropriately chosen and exchanged. Another embodiment not associated with the automated teller machine is feasible, for example.

Due to systematization of transactions of branch shops, financial institutions have succeeded in improving business efficiency and strictly controlling the transactions. Though the campaign of financial products in the business shops has become more and more important as one of the essential businesses of the shops, systems for supporting the campaign are not many and contact points with end users (customers) have often been limited to teller's windows and liaison clerks. Though campaign products are displayed on the automated teller machine that has recently acquired a high utilization ratio of customers, the products are not effectively displayed because the transactions are finished within a relatively short time. On the other hand, the customers do not have spaces and systems to easily examine or seek advices on various products of the financial institution even when they want to.

Therefore, when advertisements notifying the existence of financial products and their utilization values to the end users of the automated teller machine are put on an information displaying apparatus installed in the proximity of the automated teller machine, it may be possible to attract the attention of the end users after they finish the transactions with the automated teller machine. When such a system is set up, the financial institution may effectively increase the contact with the end users and the end users can acquire at good timing information on the financial products they want to know.

FIG. 1 is a block diagram of a hardware construction. The system includes an automated teller machine 1 that inputs transactions such as payment, receipt, check of the balance, transfer, etc, and outputs the result on the basis of the customer's operation, a server 2 that stores customer information such as the customer address, name, age, income, saving, transaction record, etc, in accordance with a CIF number and an account number (customer number) and controls channels of the automated teller machine 1 and an IS computer 3, an info-active screen computer (IS computer) 3 that controls a picture to be displayed on an info-active screen 303 and a counting system host computer 4 that executes transactions (counting system transactions) such as payment, receipt, check of the balance, transfer, etc transmitted from the automated teller machine 1 and returns the counting result to the automated teller machine 1. These automated teller machine 1, server 2, IS computer 3 and counting system host 4 are connected to one another through a network (lines). Incidentally, a plurality of automated teller machines 1 preferably exists for one IS computer 3 or one info-active screen 303 but they may correspond on the 1:1 basis, too.

The automated teller machine 1 includes a processor 100 (a semiconductor processor, for example) for processing data on the basis of a program, a memory 101 for storing a program and data, a communication unit 102 (an interface for executing protocol conversion, for example) for relaying communication with other apparatuses through the network, a card reader 103 for reading card information such as the account number from a magnetic stripe, IC chip or printing of a customer card, a display 104 (called “display unit” of automated teller machine, too) of LCD (Liquid Crystal Display) or CRT (Cathode Ray Tube) for guiding the operation of the automated teller machine 1 by the customer, an input unit 105 that accepts an instruction input of the customer on the basis of the operation guide displayed on the display 104, a cash handling unit 106 that accepts charging of cash such as bank notes and conveys and accommodates them, and a bankbook handling unit 107 that conveys a bankbook, turns pages, prints figures and returns the bankbook.

The server 2 includes a processor 200, a memory 201, a communication unit 203 and a customer file 204 for storing customer information in association with the customer number. The server 2 has a customer management function (program) for managing the customer file 203 and a channel flow control function (program) for controlling the interlocking operation of the automated teller machine 1 and the IS computer 3.

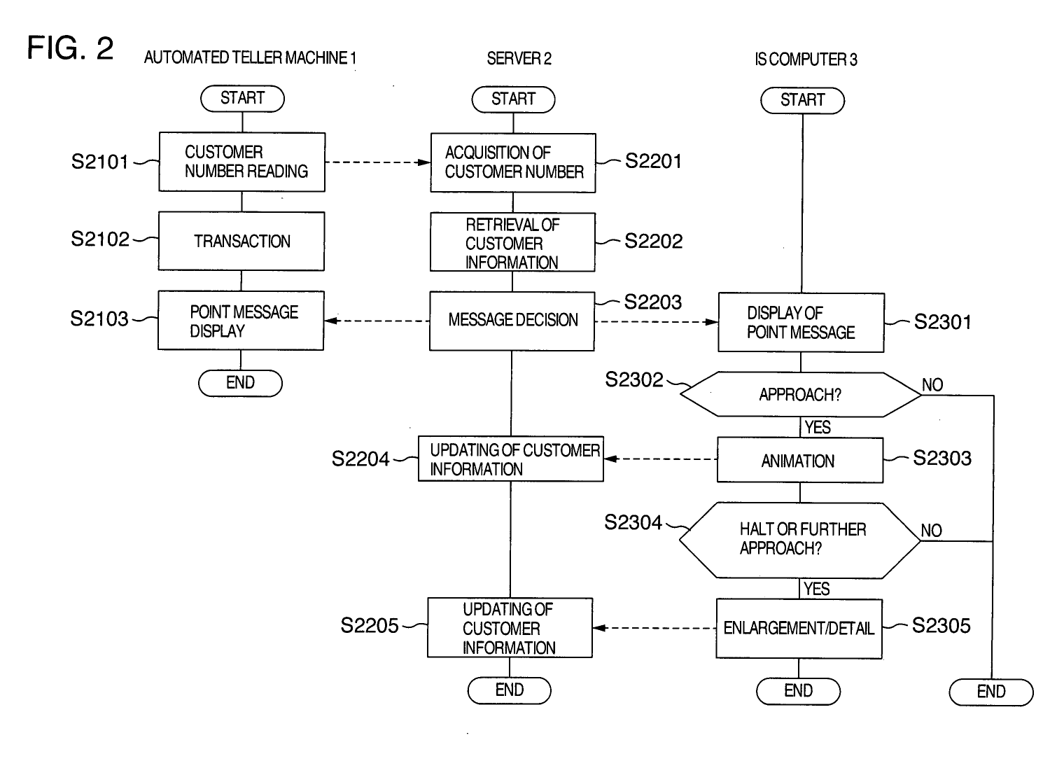

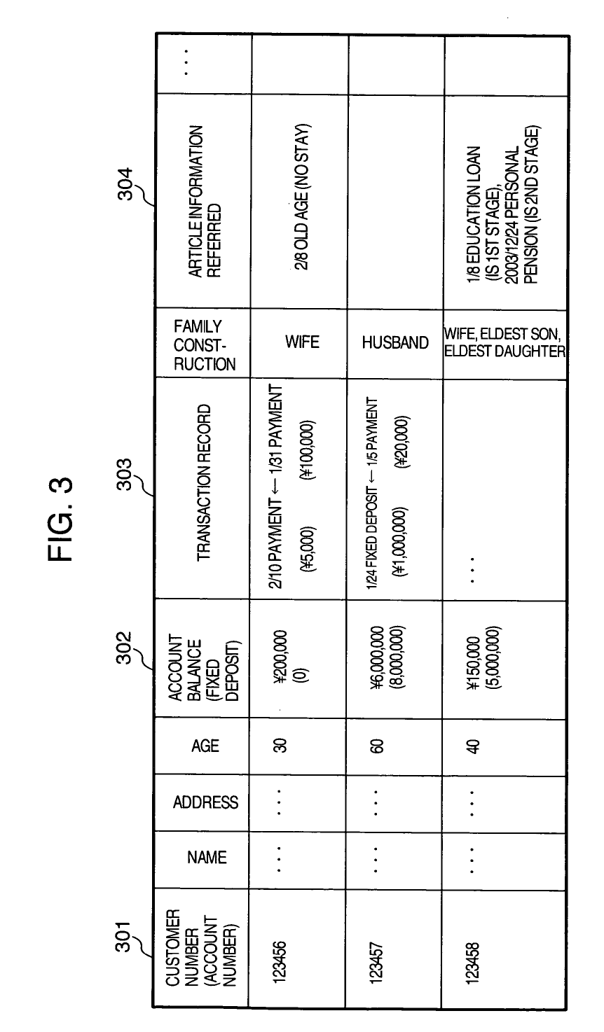

FIG. 3 shows an example of a customer information table managed by the customer file 203. This table stores the name of a customer, address, age and account balance 302 such as ordinary savings and fixed deposit, transaction record 303, family construction, reference product information 304, and so forth. The amount of the account balance 302 represents the amount of the ordinary savings and the amount inside the parenthesis represents the amount of the fixed deposit. The transaction record 303 represents the transactions from the left to the right with the latest transaction as the starting point, and represents also the date, the kind of transaction and the amount (inside the parenthesis). The product information 304 referred represents the date and the kind of the product information this customers looks up and particularly stores the content when the customer comes near to or pauses at the info-active screen 303 displaying the content (refer to S2204 and S2205 in FIG. 2).

The IS computer 3 includes a processor 300, a memory 301, a communication unit 302, an info-active screen (information display) 303 and a proximity sensor 304. The info-active screen preferably includes a large screen thin plasma display (PDP), liquid crystal display (LCD), a screen to which an image is projected from the front or back surface by a projector. The info-active screen is called a “display unit”, too. The length of a diagonal line of the display (operation guide unit) mounted to the automated teller machine is 15 inches or below but the length is at least 20 inches and preferably about 50 inches in the info-active screen. The proximity sensor 304 detects the presence of the customer near and in front of the info-active screen 303 and can specifically detect the approach of the customer or the customer who pauses in front of the screen. The proximity sensor 304 may be an optical sensor that emits rays of light such as infrared rays and detects reflection but is preferably a contact (pressure sensitive) sensor that is arranged on the floor and detects the position stepped on by the customer. Incidentally, the deed of the customer who does not leave but stays (inclusive of pause) in front of the info-active screen 303 is generically called “stay of the customer”, too. It is also possible to arrange a timer and to judge by the processor 300 that the customer “stays” when the detection time of the stay by the proximity sensor exceeds a predetermined value. It is further possible to judge the moving direction of the customer by continuously detecting the change of positions of the customer.

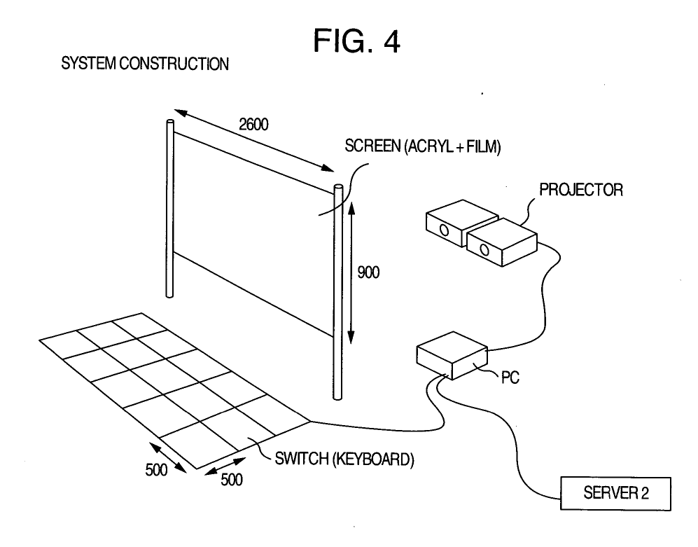

FIG. 4 is a perspective view when a rear surface projection type projector and its screen (acrylic film) are arranged as the info-active screen 303 and the proximity sensor 304, and a switch (keyboard) as a contact sensor that detects the stepping positions of the customer on the floor in an area unit of a grid form. Here, the processor 300, the memory 301 and the communication unit 302 are built in the PC. The IS computer 3 need not be formed integrally as described above. Incidentally, when the term “info-active screen system” is used, the term includes at least a part of functions of the IS computer 3 and does not limit the functions to those of the IS computer 3. The communication units 102, 202 and 302 have the transmission/reception functions and are called “transmission unit” and “reception unit” depending on their functions, too.

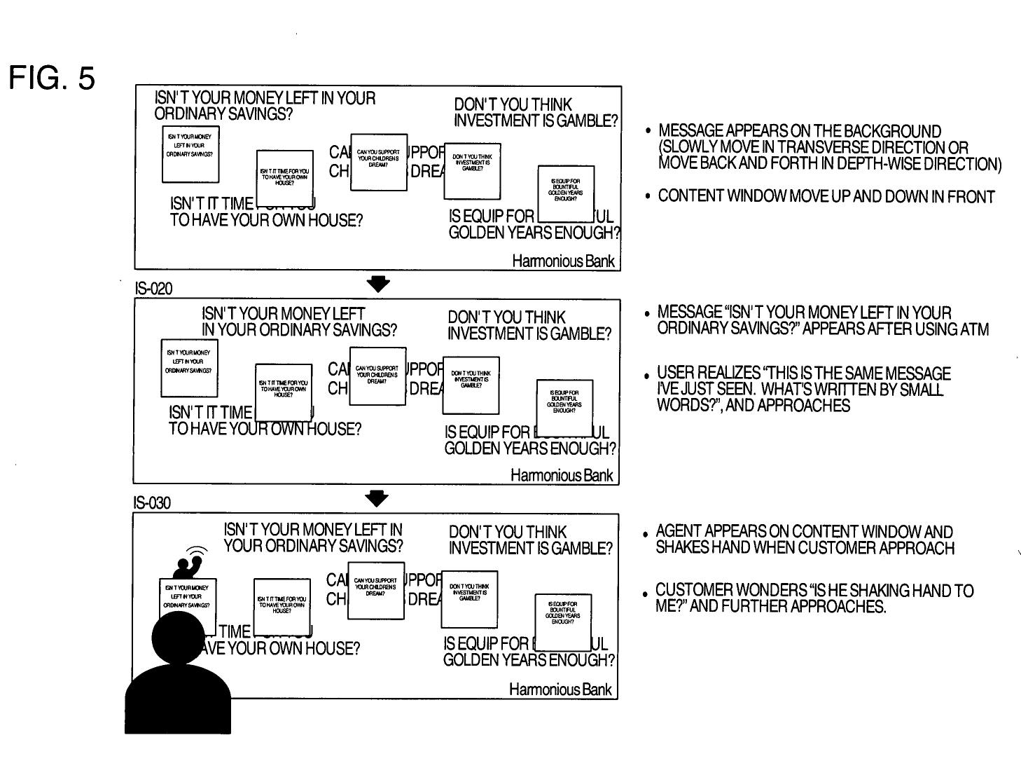

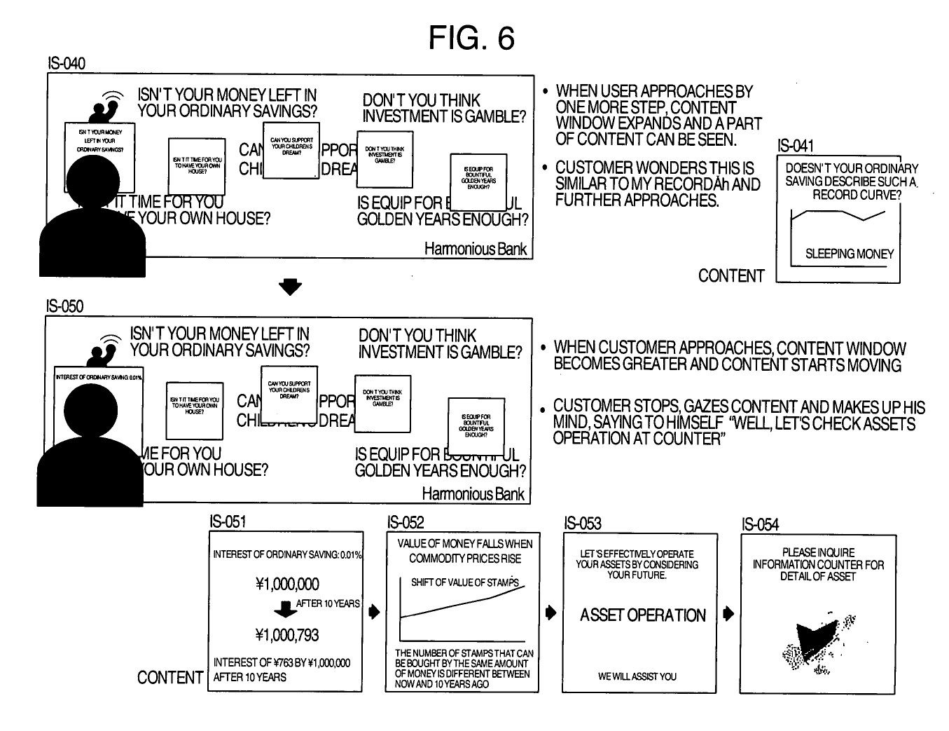

FIGS. 5 and 6 show a display example of the info-active screen 303 and an outline of the operation of the IS computer 3.

FIG. 2 is a flowchart showing the flow of a processing executed by the processors 100, 200 and 300 on the basis of the program and the data. The explanation will be given with reference to FIGS. 5 and 6.

The processor 100 acquires card information (here, account number) by the card reader 103 (S2101). The processor 100 transmits the account number acquired and apparatus stipulation information (here, apparatus number) stipulating an automated teller machine 1 from among a plurality of machines to the server 2 (S2103). Incidentally, the customer information and the apparatus stipulation information may be transmitted after the transactions are complete but are preferably transmitted at an early stage because the return transmission from the server 2 can be obtained earlier.

The processor 200 stores the account number and the apparatus number received through the communication unit 202 into the memory 201. The processing 200 retrieves the customer file 20 with the account number as the key, acquires the customer information and stores it into the memory 201 (S2201). This customer information is preferably the one obtained by receiving and reflecting the information of the transaction executed in S2102 from the automated teller machine 1 or from the counting system host 4. Assuming that a customer having a customer number “123457” transfers ¥1,000,000 from the ordinary savings to the fixed deposit on February 11 as shown in FIG. 3, for example, the account balance 302 is changed to ¥5,000,000 (¥9,000,000) and February 11 fixed deposit (¥1,000,000) is added to and corrected in the transaction record.

The processor 200 further decides a point message on the basis of the customer information stored in the memory 201 (S2202). In the case of the customer having the customer number “123457”, for example, the balance of ¥5,000,000 exists in the ordinary savings, the transfer to the fixed deposit is made recently and the customer is 60 years old and has the husband alone. From these facts, the customer is expected as need expectation to have a high interest in effective utilization of the ordinary savings. The program and the data that lead to such a need expectation based on the customer information are stored in the memory 201, and the processor 200 decides a message “Isn't your money sleeping in the ordinary savings?” as the point message that induces the effective utilization of the ordinary savings on the basis of the information of the customer file 203 and the memory 201. In another case of a customer number “123456”, the customer has a small balance in the ordinary savings, is 30 years old, has a wife (or husband) but the record shows that the customer does not show in any interest in the campaign message of the preparation for the old age. On the basis of these data, a point message “Isn't it time for you to have your own house?” is decided. In still another case of a customer number 123458, the customer is 40 years old and has two children and the record in the reference product information 304 shows that the customer feels interested in an education load. Therefore, a point message “Can you support your children's dream?” is decided.

The point message is preferably a one-phrase message that impresses the customers at a glance such as “Isn't your money sleeping in the ordinary savings?” displayed relatively largely in IS-010 in FIG. 5, but the length, the number of phrases and the information quantity are not limited. The processor 200 transmits the point message so decided to the automated teller machine 1 through the communication unit 202 (S2203).

The processor 200 transmits the point message decided, the corresponding detailed information and the apparatus number to not only the automated teller machine 1 but also the IS computer 3.

Incidentally, the quantity of information flowing through the line can be reduced by transmitting an product guide number capable of stipulating the point message and the detailed information to the IS computer but not the point message and the detailed information per se, and retrieving the point message and the detailed information corresponding to the product guide number from the memory 301 by the IS computer 3 receiving them. However, when variation of the product guide information is great or when its updating frequency is high, the product guide information is preferably transmitted from the server 2. The point message, the detailed number and the product guide number will be generically called “product guide information”.

The processor 100 transmits the account number acquired in S2101 to the counting system host and executes the transaction the instruction input of which is received in the input potion 105, by use of the cash handling unit 106 and the bankbook handling unit 107 (S2102). The processor 100 displays on the display 104 the point message received through the communication unit 102 when the transaction of the counting system is complete or during the waiting time from the counting host 4 or during the customer's waiting time such as during counting of the bank notes by the cash handling unit, printing by the bankbook handling unit, and so forth (S2104).

The processor 300 displays the point message received through the communication unit 302 on the info-active screen 303 (S2301). At this time, the point message can be displayed at the position that can attract the eyes of the customer utilizing the automated teller machine 1 having the received apparatus number on the basis of this apparatus number and is in advance designated and stored in the memory 301 (at the extreme left as indicated by IS-020 in FIG. 5, for example). For, the point message must be easily recognized by the customer and is directed to only the customer. It is also preferred to stress and magnify the point message in synchronism with the timing of the finish of the operation of the automated teller machine 1 by the customer, to change colors or to display the message in animation. In FIG. 5, for example, the point message “Don't you leave extra money in your ordinary savings?” is displayed in a greater size and in a different color in IS-020 than in IS-010. Incidentally, the point message that has been displayed so far may be emphasized in S2301 without being displayed from the beginning.

When the proximity sensor 304 detects the approach of the customer (change of non-detected state to detected state by sensor; Yes in S2302), an animation depicting an agent shaking hand is displayed near the point message (S2303; refer to IS-030 in FIG. 5). At this time, sound is outputted from a speaker, etc, to effectively attract the attention of the customer. When the proximity sensor detects that the customer does not leave but approaches (Yes in S2304), detailed information is displayed (S2305; refer to IS-040 and IS-050). Consequently, it is possible to attract the attention of the customer by the automated teller machine 1 and to enable the customer to read the message by displaying the corresponding information at the corresponding position of the info-active screen. When the change of the position of the customer along the display unit, that is, the movement of the customer along the display unit, is detected, the display position of the detailed information may be moved with the movement of the customer. It is further advisable to display the message ahead of the moving position of the customer by judging the moving direction of the customer so that the message enters the field of the moving customer.

It can be anticipated to a certain extent that the interest of the customer in the product guide is high when the customer stays at the guide and is low when the customer does not stay at the guide. Therefore, the processor 300 transmits to the server 2 the data at which information the customer stays or does not sta, and the processor 300 receiving the data stores it in the reference product information 304 of the customer file 203 and updates the data (S2303, S2305). When the movement of the customer using the automated teller machine 1 can be continuously traced from that automated teller machine 1, the customer staying at the product guide can be stipulated. For example, when the point message “Isn't your money sleeping in your ordinary savings?” is displayed for the customer having a customer number “123457”, a record “February 11 assets operation (IS second stage)” is left when the answer proves Yes in S2302 and S2304. When the answer is Yes in S2302 and No in S2304, this is the record of the IS first stage. When the answer is No in S2302, a record “non-staying” is left. This record can be reflected on the message decision in S2203 and a more effective product guide can be provided.

Even when the customer cannot be stipulated, an access ranking can be generated, for example, by acquiring an access log (count) to the product guide of indefinite customers and an product guide attracting a high interest of overall customers can be known. Such information is useful for the provision of product information to be guided later and the development of products. It is particularly effective to gather the data for each time zone and for each branch office.

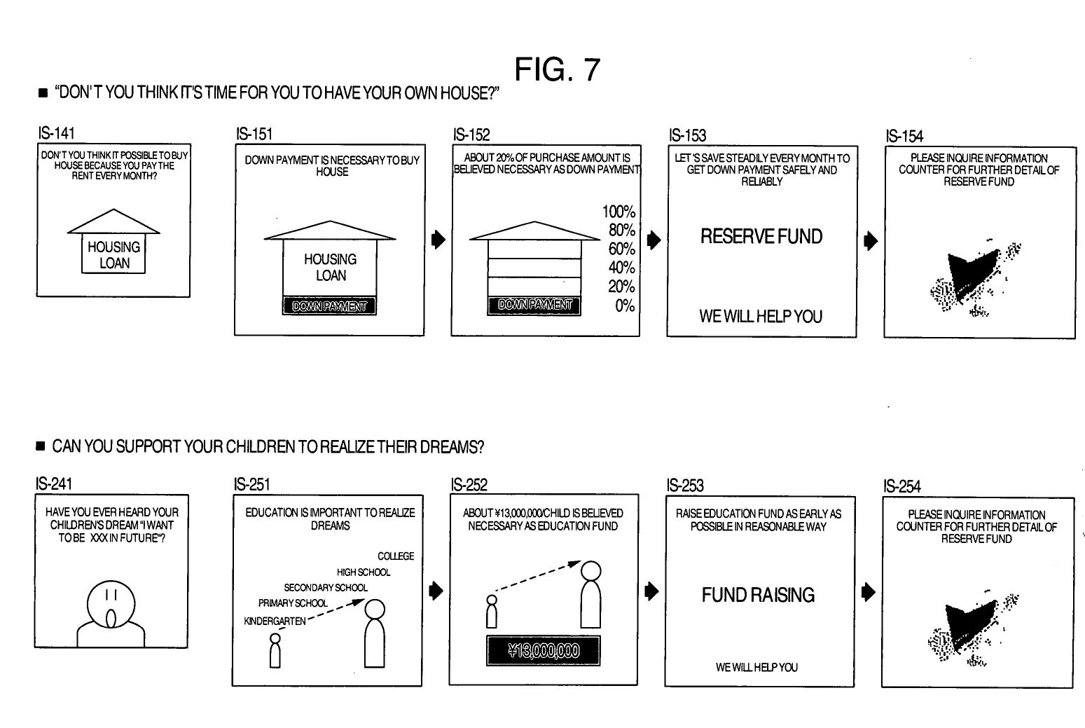

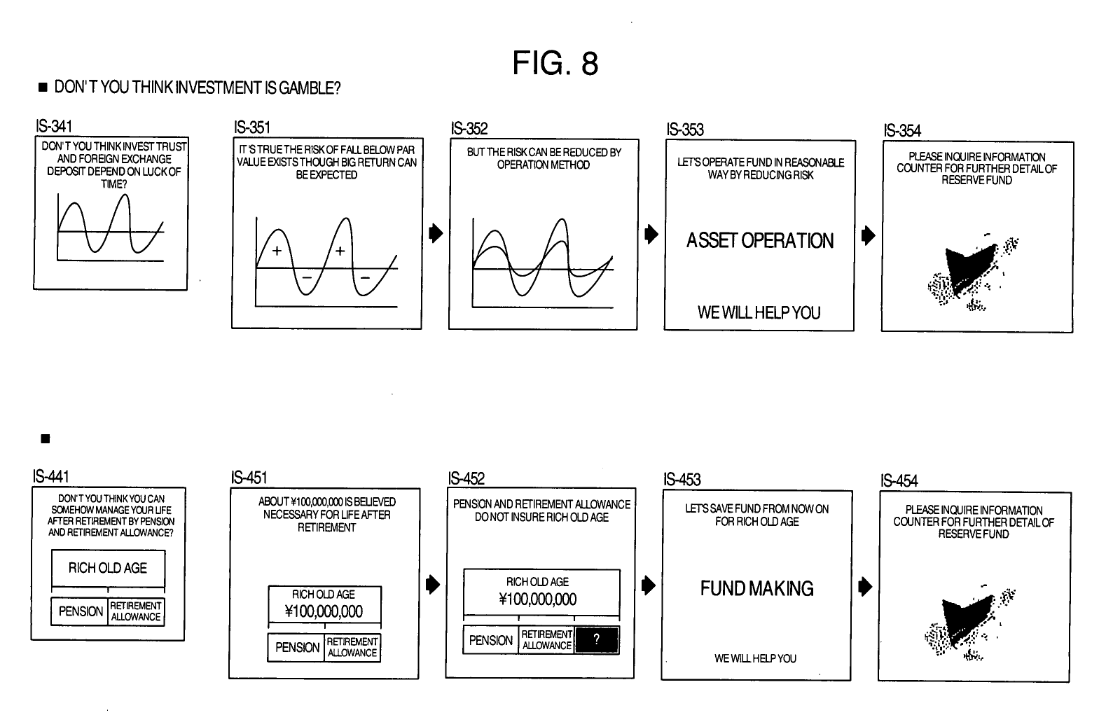

FIGS. 7 and 8 show other display examples (contents) of the detailed information for each point message reproduced in IS-050 of FIG. 6. Simulation using numerical values is particularly effective for the guides of the financial products. Guidance that finally induces the customer to an information counter at which the customer can acquire more detailed information is displayed.

The term “product guide” used above is not particularly limited to financial products. The product guide includes those which do not advertise product names but invite consultation of customers unless otherwise stipulated explicitly.

The customer management function and the channel flow control function need not be integrated with each other in the server 2 but may be separate. When the servers are separate, the server having the customer file and the customer management function is called “customer management server” and the server having the channel flow control function is called “interlocking operation control server”, too. In this case, it is preferred that the interlocking operation control server mainly executes the flowchart executed by the server 2 in FIG. 2 and the instruction of the processing in S2202, S2204 and S2205 is transmitted to the customer management server. The info-active screen system includes in some cases the channel flow control function and the function of the IS computer 3.

As described above, because the content positively acts on the customer, this embodiment can draw the attention of the customer walking near the info-active screen 303 and can give further information to those who show any interest. Channel interlocking operation and information utilization are made between the automated telling machine and the info-active screen. The embodiment provides “notice” and induces the customer to understanding. The financial institutions can take a log as to which content has drawn attention (by taking the staying time of the customer at each content).

Though the interlocking operation with the point message of the automated teller machine has been described in this embodiment, a system shown in FIG. 4 can be operated without the interlocking operation with the point message. In this case, too, the information in which the customers seem showing any interest by his halt or approach can be provided and/or gathered by displaying in detail the content in accordance with the detection by the switch keyboard as described in S2305.

It should be further understood by those skilled in the art that although the foregoing description has been made on embodiments of the invention, the invention is not limited thereto and various changes and modifications may be made without departing from the spirit of the invention and the scope of the appended claims.

1. An information displaying system connected to an automated teller machine having an operation guide unit for displaying an operation guide for customers, comprising:
a reception unit for acquiring customer information from the automated teller machine;
a processor for deciding a message on the basis of the customer information acquired in the reception unit; and
a display unit different from the operation guide unit, for displaying an product guide inclusive of the message.

2. An information display system as defined in claim 1, which further comprises:
a sensor for detecting stay of a customer in front of the display unit, wherein:
the processor displays on the display unit detailed information of an product guide displayed on the display unit when the sensor makes detection.

3. An information display system as defined in claim 1, which further comprises:
a sensor for detecting stay of a customer in front of the display unit, wherein:
the processor records an product guide displayed on the display unit when the sensor makes detection.

4. An information display system as defined in claim 3, wherein the processor record information representing the product guide in association with the customer information when it records the product guide.

5. An information display system as defined in claim 1, wherein the automated teller machine further includes a medium read unit for reading a transaction medium, wherein the reception unit acquires customer information read by the medium read unit from the transaction medium.

6. An information display system as defined in claim 1, wherein decision of the processor is made by a deposit balance, family construction or transaction history corresponding to customer information received by the reception unit.

7. An information display system as defined in claim 1, wherein the customer information includes an account number.

8. An information display system as defined in claim 1, which further comprises:
a transmission unit for transmitting a message decided by the processor to the automated teller machine, wherein:
the automated teller machine displays the message on the operation guide unit.

9. An information display system as defined in claim 1, wherein the display unit displays an product guide inclusive of the message at a position corresponding to the apparatus stipulation information.

10. An information display system as defined in claim 1, wherein the display unit includes a plasma display panel or projection type projector having a size of 20 inches or more.

11. An information displaying system separate from an automated teller machine and connected to the automated teller machine through a line, wherein the same point message as a point message of an product guide displayed on the automated teller machine is displayed in such a manner as to correspond to finish of an operation or finish of transaction in the automated teller machine.

12. An information display system comprising:
a reception unit for receiving product guide information for stipulating a guide of an product and apparatus stipulation information for stipulating an automated teller machine; and
a display unit for displaying a display corresponding to the product guide information received by the reception unit at a position so designated as to correspond to the apparatus stipulation information received by the reception unit.

13. An information displaying system comprising:
a display unit for displaying an product guide;
a sensor for detecting stay of a customer; and
a processor for switching the product guide information on the basis of detection of the sensor.

14. An information displaying system as defined in claim 13, wherein the processor switches a display to detailed product guide information of the product guide information displayed when the sensor detects the stay of the customer.

15. An information displaying system as defined in claim 13, wherein the sensor detects approach of a customer to the display unit and/or halt of the customer for a predetermined time as the stay.

16. An information displaying system as defined in claim 13, wherein the sensor includes a contact sensor arranged on a front floor of the display unit and/or an optical sensor for detecting reflected light to emitted light.

17. An information displaying system as defined in claim 13, wherein the processor transmits a kind of product guide information switched to a high order apparatus.

18. An information displaying system as defined in claim 17, wherein the high order apparatus stores the kind of the product guide information received from the processor in association with time.

19. An information displaying system as defined in claim 13, wherein the processor moves a display position of the product guide information with movement of a customer when the sensor detects the movement of the customer.

20. An information displaying system as defined in claim 13, wherein the processor controls speech output when the product guide information is displayed.
